(19) United States
(12) Patent Application Publication
(10) Pub. No.: US 2018/0204243 A1
(43) Pub. Date: Jul. 19, 2018

(54) Social Media Influencer Group Management

(71) Applicant: Vity Patent Holdco, LLC, Loveland, CO (US)

(72) Inventor: Lynne Haaland, Burbank, CA (US)

(21) Appl. No.: 15/406,539

(22) Filed: Jan. 13, 2017

(51) Int. Cl. G06Q 30/02

(52) U.S. Cl. CPC G06Q 30/0243; G06Q 30/0277; G06Q 30/0251

(57) ABSTRACT

Groups of social media influencers may be organized and managed to execute advertising campaigns. The groups may be organized to reach targeted demographics for the campaign. The management tools for the group may include synchronization and timing interfaces that may coordinate and schedule posts amongst the group members, feedback and analytics displays that may show progress against group and individual goals, and interaction mechanisms by which group members may communicate. In some cases, groups may be self-organizing, where a group member may recruit and manage other members. In other cases, groups may be organized by an advertiser, or may be organized by a third party, such as an advertising platform.

### BACKGROUND

Online social media is one of the most used ways people communicate with each other. Family and friends share information about their various happenings online, but many platforms allow for users to follow other users and consume content from anyone within the various social media platforms.

Influencers are commonly thought of as those people who have amassed large online followings. These influencers can get paid to advertise for various brands. An influencer with 100,000 followers might be asked to review a product or post a favorable advertisement, and that influencer might be paid for the action.

Brands may pay influencers for their posts. Brands may have advertising campaigns that may get the word out to their target market. An advertising campaign may be designed to “engage” with a customer. In some cases, the engagement may be to have a user view an advertisement, while other times it may be to repost an advertisement, while still other engagements may be to interact with other online content sponsored by the brand. In many cases, the ultimate engagement may be for the user to purchase a product or service provided by the brand.

### SUMMARY

Groups of social media influencers may be organized and managed to execute advertising campaigns. The groups may be organized to reach targeted demographics for the campaign. The management tools for the group may include synchronization and timing interfaces that may coordinate and schedule posts amongst the group members, feedback and analytics displays that may show progress against group and individual goals, and interaction mechanisms by which group members may communicate. In some cases, groups may be self organizing, where a group member may recruit and manage other members. In other cases, groups may be organized by an advertiser, or may be organized by a third party, such as an advertising platform.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1A is a diagram illustration of an example embodiment showing a user interface for browsing and selecting groups of influencers.

FIG. 1B is a diagram illustration of an example embodiment showing a chart with demographic or topical coverage.

FIG. 1C is a diagram illustration of an example embodiment showing a chart with geographic coverage.

FIG. 2 is a diagram illustration of an embodiment showing a schematic or functional representation of a network with an influencer group management system.

FIG. 3 is a flowchart illustration of an embodiment showing a method for using groups of influencers for advertising campaigns.

FIG. 4 is a flowchart illustration of an embodiment showing a method for using influencer groups.

FIG. 5 is a flowchart illustration of an embodiment showing a method for creating influencer groups.

### DETAILED DESCRIPTION

Social Media Influencer Group Management

Groups of social media influencers may be organized and managed to execute advertising campaigns. The groups may be organized to reach targeted demographics for the campaign. The management tools for the group may include synchronization and timing interfaces that may coordinate and schedule posts amongst the group members, feedback and analytics displays that may show progress against group and individual goals, and interaction mechanisms by which group members may communicate. In some cases, groups may be self organizing, where a group member may recruit and manage other members. In other cases, groups may be organized by an advertiser, or may be organized by a third party, such as an advertising platform.

Social media influencer advertising leverages the trust that people build with influential people. These influencers have a name brand or reputation usually built by generating content within a social media platform. Some influencers may have established a reputation and following in the entertainment or sports fields, and that reputation may follow them onto different social media platforms.

Advertising with a group of social media influencers may have powerful multiplying effects. Advertising messages often take several impressions before a customer may respond. By targeting customers through several different influencers, an advertiser may be able to get improved coverage and the multiple impressions that may cause a customer to respond to an advertisement.

The group management tools may allow advertisers to curate campaigns to reach customers from multiple vectors. For example, an advertiser may wish to reach outdoor enthusiasts who are vegan. A group of social media influencers may be generated from vegan influencers as well as influencers with a following who enjoy outdoor activities. Such a group may be designed so that the target may be the intersection of one influencer's demographics with a second influencer's demographics.

Such a group may be instructed to provide content targeted at the intersection. For example, a vegan influencer may provide advertisements directed toward outdoor enthusiasts, and the influencer with lots of outdoor enthusiasts as followers may post topics relating to vegans. In such a manner, the coordinated effort of the two types of influencers may target the specific group of customers.

Another use of the group management tools may include broadening the coverage of any individual influencers. For example, certain influencers may have enthusiastic followings in each of their respective cities and local areas. A group may be created to combine several influencers with specific geographic coverages into a group that covers a larger geographic area.

Still another use of the group management tools may include combining the forces of individual influencers. Influencers within a group may be incented to cross-post or otherwise interact with each other and boost each other's advertisement influence.

Such interaction may have a multiplying effect in several ways. In many social media platforms, posts may be ranked based on not only the number of people who viewed, commented, reposted, or otherwise interacted with a post, but by the importance or influence of the person who interacted with the post. An influential person who left a comment or responded to a post will give that post a much higher importance. Many social media platforms will give important posts a much higher visibility than posts it deems less important.

Another multiplying effect may be from any cross talk or interaction between influencers. People who follow these influencers are often more engaged when they see influential people interact with each other. This dynamic may help group advertising campaigns to have increased exposure and increased influence.

Still another multiplying effect may be the exposure that one influencer can get from another. Each time an influencer responds to another influencer's post, followers of each influencers may be exposed to the other influencer. Typically, these types of interactions will add followers to both influencers, thereby increasing the reach and influence of both influencers.

When an advertiser wishes to reach a certain audience, a group of influencers may be created. The influencers may be selected to have reach into specific demographics, and a group may be created that has complementary coverage into the target demographic.

Groups may be created in several different ways. In a simple mechanism, an advertiser may review profiles for influencers and invite them into a group. The advertiser may review demographics about the influencer's followers, and the advertiser may manually select and hand pick each influencer that may be invited.

In another mechanism, a marketing professional may manually curate groups for specific topics or demographics. For example, a group may be created for targeting people in the finance industry, or another group may be created for college freshman in the Northeast, or other groups may be created for specific demographics.

In such a system, an advertiser may search a list of predefined groups and select one that may be appropriate for their campaign. The advertiser may be able to add or remove influencers from the selected list to customize the list for their uses.

Influencers may be able to curate and manage their own group. Influencers may gather a group of friends or other influencers to form their own group. Such groups may have the advantage that the influencers may operate as a team, helping each other generate content and reach certain demographics.

In still another mechanism, groups may be assembled automatically to meet a given demographic. An advertiser may list their demographic, and an advertising platform may search its influencers to find matches. The advertising platform may assemble several influencers into a group that may cover the targeted demographic. After automatically assembling the group, an advertiser may be able to add or remove influencers and make adjustments to the group.

The groups may be paid using various payment options. In one option, each influencer may be paid individually for their contributions. In such an option, each influencer may be paid for each post, conversion, or other performance metric.

Some groups may be paid collectively. Influencers may band together to do a campaign and may divide the income amongst themselves. One method of dividing the income may be to pay each influencer based on the number of followers they have, while another method might be to pay each influencer based on the number of posts they produced. Still another method may be to pay each influencer based on a formula that takes into account their followers and the amount of work they performed on a given campaign.

Groups may divide up the income using a combination of shared monies that may be distributed amongst all participants, as well as incentives or performance bonuses for individual influencers.

An advertising platform may have several tools for enhancing and facilitating the dynamics within members of the group. The tools may include a repository of assets for a campaign, as well as group discussion boards, scheduling mechanisms for posts, engagement meters and other performance metrics, comparisons and rankings for influencers within the group, comparisons and rankings of the group against other groups, and other tools.

Most social networks have public facing content that may be viewed by all of someone's followers, as well as private facing content that may be viewed by only certain people. Some networks have group discussion boards and other communication channels by which an influencer group may communicate between themselves.

In many cases, a lead influencer or group manager may manage the other influencers by scheduling the campaign, reminding group members when to post items, analyze the performance of the group against campaign goals, and provide feedback to group members. The lead influencer may be an influencer who may organize and manage a group, but in other cases, the lead influencer may be an advertiser representative who may manage the group dynamics.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

In the specification and claims, references to “a processor” include multiple processors. In some cases, a process that may be performed by “a processor” may be actually performed by multiple processors on the same device or on different devices. For the purposes of this specification and claims, any reference to “a processor” shall include multiple processors, which may be on the same device or different devices, unless expressly specified otherwise.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory. When the subject matter is embodied in “non-transitory” media, the media may be any storage media that expressly does not include live signals.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

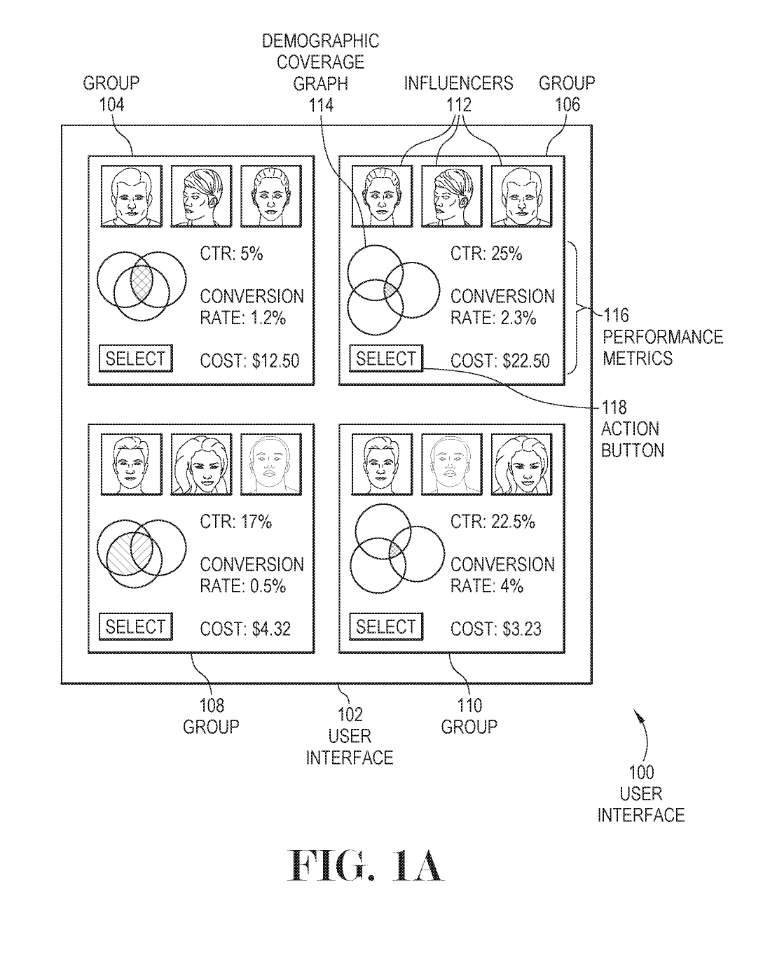

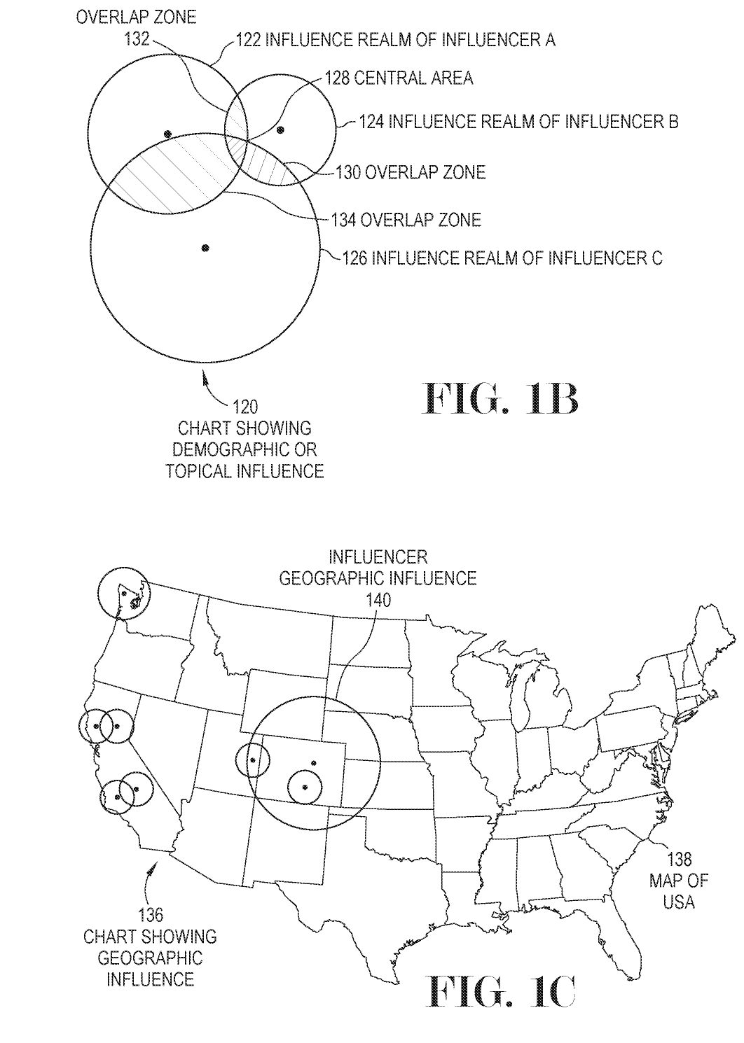

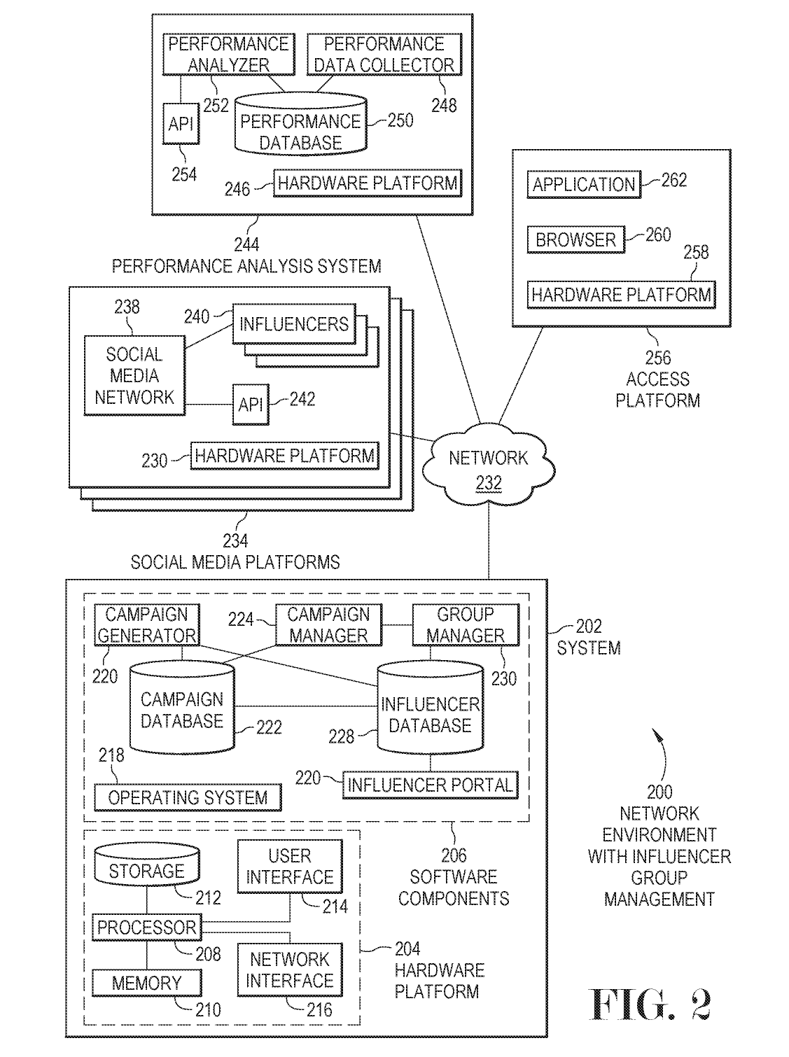

FIG. 1A is a diagram illustration of an example embodiment 100 showing a user interface 102. The user interface may be a simplified version of a user interface that an advertiser may use to select a group for a specific advertising campaign.

Embodiment 100 is an example of a user interface 102 that may show several influencer groups 104, 106, 108, and 110. Each of the influencer groups may be a group of individual influencers that may execute an advertising campaign.

In a typical influencer advertising campaign, a brand or advertiser may define objectives for the campaign, such as to sell a certain amount of product or create brand awareness. In many cases, the campaign objectives may be more specific, such as to draw a certain number of consumers into a sales funnel or to establish a certain amount of consumer engagement.

Performance goals for a campaign may be goals that may be measured through various tracking mechanisms. One tracking mechanism may be to use a customized Uniform Resource Identifier (URI) or Uniform Resource Locator (URL) in various collateral. The customized URI or URL may send a consumer from an advertisement by an influencer into a landing page or other location that may be tracked. Because each URI or URL may be different for each influencer, the performance of individual influencers may be monitored and measured.

Tracking mechanisms may be created to track group performance instead of or in addition to tracking performance of individual influencers. In some systems, each influencer's performance may be measured and the group performance may be the aggregated performance of each influencer. In other systems, tracking mechanisms may be deployed to measure performance of any member of a group and the individual influencer's performance may or may not be separately identified.

Group-only tracking mechanisms may be useful in cases where a group of influencers operate as a unit, as opposed to campaigns where influencers operate independently. For example, influencers may cross-post or interact with each other as part of a campaign. Such actions may generate consumer responses that may not be directly attributed to a single influencer but may be attributed to the combined efforts of two or more influencers in the group. As such, the performance statistics may be gathered and calculated as group statistics.

Each group may be made up of several influencers. In the example of group 106, a set of three influencers 112 may be illustrated. The example of three influencers was selected merely for illustration purposes. In some cases, a group may consist of two, three, four, or more influencers. Some groups may have a handful of influencers, while other groups may have ten, twenty, fifty, a hundred, or more influencers.

Statistics or other information may be provided for individual influencers. Such information may include the influencer's name or handle, their followers, various demographic information about them and their followers, their expected cost for performance, as well as performance statistics. Performance statistics may include conversion rate, response rate, and other performance related statistics.

A user interface may show such individual information for each influencer using many different mechanisms. In some cases, such information may be displayed on a view such as the example of user interface 102. In other cases, such statistics may be displayed on a mouse hover operation, after clicking on the influencer, or after some other action may be taken by the viewer of the user interface 102.

The groups 104, 106, 108, and 110 may be generated by several different mechanisms. In one mechanism, an automated system may create a group by analyzing various campaign parameters and selecting a group to meet those parameters. Another mechanism may be for an advertiser, agency, marketplace, or other affiliated person to manually select influencers for a group. Still another mechanism may be for an influencer to recruit other influencers to coalesce into a group. Yet another mechanism may be for groups that may have previously worked together to remain as a group for future campaigns.

A demographic coverage map 114 may be displayed for each of the various groups. The demographic coverage map 114 may be a Venn diagram, map, or some other representation of the coverage that the influencers may have as a group. The coverage may be defined and displayed as geographic coverage, but also as topical, demographic, or other coverage parameters.

The demographic coverage map 114 is merely one example of a demographic coverage statistic. In some cases, as in embodiment 100, the demographic coverage statistic may be illustrated in graphical form. In other cases, the demographic coverage statistic may be presented in numerical form.

A set of performance metrics 116 may be displayed for each group. The performance metrics 116 may reflect the past performance or estimated future performance of the group of influencers. In some cases, such metrics may be aggregated from performance metrics of each influencer, such as a group conversion rate that may be an average or weighted average of the conversion rate of each influencer. In other cases, the metrics may be the past performance of the group of influencers as measured on previous campaigns.

The example of embodiment 100 illustrates an example of performance metrics that may be illustrated in numerical form. Other embodiments may show graphical or other pictorial representations of performance metrics.

Each group may have an action button 118 which may allow a user to select a group for further evaluation or engagement on a campaign. The action button 118 may be any type of user interface device by which a user may select a group, which may trigger other actions in a process of evaluating or engaging a group of influencers.

FIG. 1B is an illustration of an example embodiment 120 showing a chart of demographic or topical influence. Example embodiment 120 is merely one example of a visualization of an aggregation of demographic or topical parameters that may be useful in a campaign.

In many campaigns, an advertiser or brand may identify one or many demographic or topical parameters for a campaign. Examples may include demographic profiles such as age, gender, education, marital status, job status, education, income, religion, race, and other parameters. Other examples may also include topical interests, such as hobbies, expertise, or areas of interest. Examples may include interests in sports such as tennis or golf, food, health, art, music, travel, or any other interest or parameter.

Each influencer may reach a demographic that can be analyzed using the demographic or topical parameters. In many cases, the demographic or topical parameters may be determined by analyzing the influencer's followers and aggregating the follower's demographic profiles and topics of interest. For example, an influencer's followers may be analyzed to determine their age, gender, location, education, marital status, race, religion, and other parameters. In some cases, any interests, hobbies, areas of interest, and other topical parameters may also be gathered. A demographic profile of the influencer's followers may be the sum or aggregation of all of the demographic and topical parameters of all the followers.

Some systems may assign interests or topics by analyzing a follower's response rate to specific topics. Such systems may give higher weights to followers that have higher engagement with the influencer or higher engagement with specific topics.

In some cases, certain demographic or topical parameters may come from the influencer. For example, the demographic profile of the influencer may include the influencer's age, gender, education, and other parameters, as well as the influencer's topics of interest. As a notational shorthand for this specification and claims, references to an influencer's demographic profile may include demographic or topical information from

Each influencer may different demographic profiles. For a group of influencers, the demographic profiles may overlap and may complement each other. The chart of embodiment 120 may graphically show the profiles of different influencers and how those profiles overlap in a Venn diagram. Each influencer may have a realm of influencer 122, 124, and 126. A central area 128 may be the overlap of all three influencers, while overlap zones 130, 132, and 134 may be the overlap of two influencers.

The chart of embodiment 120 may graphically depict a specific aspect of a group of influencers that may be relevant to a given advertising campaign. One example may be to show influencers that may each have a primary demographic parameter and show how much overlap might exist between the influencers. For example, a campaign may wish to reach people with interests in animals, automobiles, and travel. A graph may be created to show the group's followers or audience that share those interests. In such an example, the overlap zone 130 may show the audience size that share all three interests, while the other zones may show the audience size that share one or two of the interests but not all three.

FIG. 1C is a diagram illustration of an embodiment 136 showing a geographic realm of influence for a group of influencers. A map 138 of the United States may have several influencers' geographic influence 140.

Embodiment 136 may represent yet another graphical view of demographic, topical, or performance information. In this case, the information may be displayed on a geographic map. Such information may be useful when a campaign may focus on geographic aspects of marketing, such as when a product may be targeted to certain locations, or when an advertiser may wish to reach consumers across various geographic regions. The information displayed may represent the intensity or outreach of influencers in different geographies.

Embodiment 136 is merely another example of how various information about multiple influencers may be displayed for an advertiser, account executive, marketing manager, or other marketing professional to interact with.

The information displayed in a graphical form may include performance information about individual influencers as well as the group of influencers. For example, the graph of embodiment 136 may be used to display the response rate, conversion rate, or some other performance metric for an individual influencer or for a group of influencers.

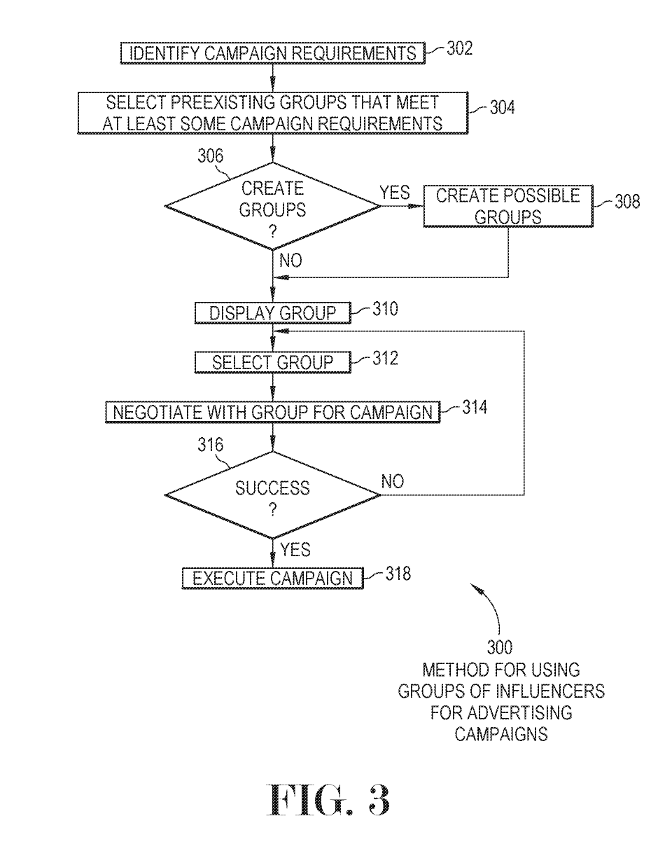

FIG. 2 is a diagram of an embodiment 200 showing components that may manage influencer marketing campaigns. The components are illustrated as being connected across a network 240.

The diagram of FIG. 2 illustrates functional components of a system. In some cases, the component may be a hardware component, a software component, or a combination of hardware and software. Some of the components may be application level software, while other components may be execution environment level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 illustrates a device 202 that may have a hardware platform 204 and various software components. The device 202 as illustrated represents a conventional computing device, although other embodiments may have different configurations, architectures, or components.

In many embodiments, the device 202 may be a server computer. In some embodiments, the device 202 may still also be a desktop computer, laptop computer, netbook computer, tablet or slate computer, wireless handset, cellular telephone, game console or any other type of computing device. In some embodiments, the device 202 may be implemented on a cluster of computing devices, which may be a group of physical or virtual machines.

The hardware platform 204 may include a processor 208, random access memory 210, and nonvolatile storage 212. The hardware platform 204 may also include a user interface 214 and network interface 216.

The random access memory 210 may be storage that contains data objects and executable code that can be quickly accessed by the processors 208. In many embodiments, the random access memory 210 may have a high-speed bus connecting the memory 210 to the processors 208.

The nonvolatile storage 212 may be storage that persists after the device 202 is shut down. The nonvolatile storage 212 may be any type of storage device, including hard disk, solid state memory devices, magnetic tape, optical storage, or other type of storage. The nonvolatile storage 212 may be read only or read/write capable. In some embodiments, the nonvolatile storage 212 may be cloud based, network storage, or other storage that may be accessed over a network connection.

The user interface 214 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 216 may be any type of connection to another computer. In many embodiments, the network interface 216 may be a wired Ethernet connection. Other embodiments may include wired or wireless connections over various communication protocols.

The software components 206 may include an operating system 218 on which various software components and services may operate.

A campaign generator 220 may be a mechanism which may include a user interface by which an influencer marketing campaign may be generated. In a campaign generator, a user may define various parameters about an influencer campaign, such as the goals and objectives, targets for topics, demographics, or other descriptors of the intended audience, pricing or other cost information, collateral to be used during the campaign, and other parameters. The campaigns may be stored in a campaign database 222.

A campaign manager 224 may be a mechanism which may include a user interface by which an ongoing campaign may be managed. The campaign manager 224 may have mechanisms for a marketing manager to change parameters or goals of a campaign, to interact with the influencers, as well as to approve content generated by influencers, pay the influencers, and many other functions.

Influencers may interact with the system through an influencer portal 226. The influencer portal 226 may have mechanisms for influencers to upload and manage their accounts and profiles, and through which influencers may join various influencer groups. The influencer information may be stored in an influencer database 228.

A group manager 230 may have mechanisms by which a manager of an influencer group may interact with the system 202. The manager of a group may be an influencer who may recruit other influencers in to a group, or may be a marketing manager or other advertising professional who may curate and manage the group. The group manager 230 may have mechanisms for adding and removing group members, and communicating with individual influencers or the entire group. In some cases, the group manager 230 may have the ability to negotiate terms and conditions with an advertiser, including pricing and performance terms.

A network 232 may connect various systems and platforms. In many cases, the network 232 may be the Internet.

Various social media platforms 234 may be the platforms on which influencers 240 may engage with other users and may share content as part of an advertising campaign.

A social media network 238 may operate on a hardware platform 236, and may host the influencers 240. In many cases, an application programming interface 242 may be available for collecting information about activities on the social media network 238. Such information may include analytics that may be used to identify posts made by influencers 240 as well as the responses or reactions to those posts.

A performance analysis system 244 may be an analytics platform which may gather performance metrics about influencer activities on a social media network. The performance analysis system 2444 may operate on a hardware platform 246 and may include a performance data collector 248, which may store data in a performance database 250. A performance analyzer 252 may analyze and aggregate data, which may be made available through an application programming interface 254.

A typical device 256 for accessing the various platforms may be a desktop or portable device, although many other devices may also be used. Such systems may have a hardware platform 258 on which a browser 260 or application 262 may communicate with the system 202, social media platforms 234, or performance analysis system 244.

FIG. 3 is a flowchart illustration of an embodiment 300 showing a method performed when an advertiser creates and executes a campaign.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 may be a method performed by a computerized influencer group management system, such as the system 202 of embodiment 200. In some cases, certain portions of the method may be performed automatically, which in other cases, some portions may be performed with user input. A computerized influencer group management system may have user interfaces, application programming interfaces, or other mechanisms to interact with users or other systems.

Embodiment 300 illustrates a basic method for using groups of influencers for an advertising campaign. Campaign requirements may be defined in block 302. From the requirements, preexisting groups may be searched in block 304 to find any groups that meet at least some of the campaign requirements.

Many systems may have preexisting groups. The groups may be curated by an advertising professional or other third party, who may select influencers that may be effective at meeting specific goals or addressing certain topics. For example, an influencer group may be curated to address cosmetics for women aged 18-25 of a certain ethnicity. Such a group may be composed of influencers of that ethnicity who use or have promoted cosmetic products. Such a group may also include influencers who may not be of that ethnicity but may have a following that contains a sizeable percentage of ethnic consumers. Such a group may be curated by identifying a large group of influencers who may reach the target consumer.

Another group may be curated to reach a broad spectrum of pet owners. Such a group may be curated with a few influencers who target younger pet owners, as well as some influencers who target middle aged pet owners, and still more influencers who may reach older pet owners. Some influencers may concentrate on specific types of pets, such as cats, dogs, fish, reptiles, horses, or other categories. Some influencers may have a concentration on indoor pets while other influencers may concentrate on outdoor animals. Such a group may be curated to reach a wide demographic, where a curator may analyze the demographic coverage, identify weaknesses, then find an influencer who may fill in the weak area of coverage.

In many systems, groups may be reused from previous campaigns. Groups with a performance history may give an advertiser confidence that the group may perform well in a future campaign.

Groups may change from one campaign to another. In some cases, a group may execute a campaign and influencers may be added or removed before executing a second campaign. Such changes may be made by the influencers who may voluntarily leave a group or may request to be added, or such changes may be made by a curator or manager who may remove duplicative or underperforming group members and may add new influencers who may be higher performing or who may have an audience reach that may be underrepresented in the group.

Some groups may be self-organizing and self-managed. Such groups may be curated by one influencer, who may add other influencers into the group. Influencer-managed groups may be organized by influencers who wish to work together by interacting with each other as part of a campaign. Such groups may perform better in some circumstances than groups where the influencers may not know each other and may not worth collaboratively.

In some cases, a decision may be made in block 306 to create a group, which may be created in block 308. One process for making a group may be found in later embodiments. Some groups may be created automatically or with computer assistance in finding groups that meet a campaign goal.

The groups may be displayed in block 310. In a typical user interface, demographic and performance information may be displayed in graphical or numerical form. Such information may help an advertising professional select a group in block 312.

Once a group may be selected in block 312, a negotiation may occur in block 314 for a campaign. If the negotiation is not successful in block 316, the process may loop back to block 312 to select another group. When the negotiation is successful in block 316, the campaign may be executed in block 318.

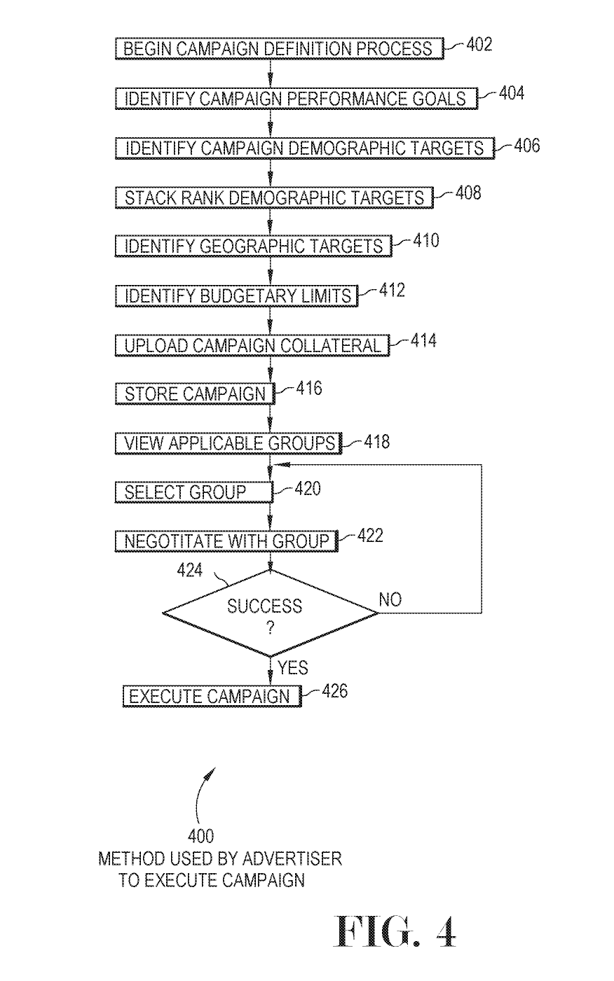

FIG. 4 is a flowchart illustration of an embodiment 400 showing a method that may be used by an advertiser to execute a campaign. The process includes setting up a campaign so that applicable influencer groups may be identified, then selecting an influencer group to execute the campaign.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 400 may be a process that an advertiser may use with a group management system, such as the influencer group management system 202 of embodiment 200. The influencer group management system 202 may have user interfaces, application programming interfaces, and other mechanisms by which a user may interact with the system. In some cases, some of the steps in embodiment 400 may be performed automatically or with some computer assistance from the system 202 or a similar system.

The campaign definition process may begin in block 402.

Campaign performance goals may be identified in block 404. The performance goals may be any metric that may define success for a campaign. A performance goal may be as simple as the number of posts, or may include items like the number of views, responses, clicks, conversions, email collected, sales completed, downloads, or some other metric. In many cases, the performance goals may be something that may be tracked using an analytics system.

Many systems may have a user interface by which a user may identify and quantify performance metrics for a campaign. Some systems may have the ability to define a funnel or pipeline of actions that a consumer may follow to achieve a conversion or sale. Some such systems may allow a user to define performance goals for each step in the conversion process.

Demographic targets for the campaign may be identified in block 406. The demographic targets may be used to help identify influencers. Some systems may correlate the demographic target with a set of influencers who may reach the demographic. A typical system may have a user interface through which a user may select demographic parameters and define values or a range of values for each of the parameters.

The demographic targets may be stack ranked in block 408. Stack ranking may be one mechanism by which priorities may be set for the demographic parameters. The prioritization of demographic parameters may help create and evaluate influencer groups to match a campaign's priorities.

The geographic targets may be identified in block 410. Some campaigns may have specific geographic targets, which may be entered into a user interface. The geographic targets may help in identifying and curating influencers and influencer groups to match a campaign.

Campaign budgets may be identified in block 412. Budgets may be used by an influencer group management system to match influencers and influencer groups. Some systems may have a budget advisor which may suggest appropriate budgets for certain influencer groups and campaign objectives.

Many campaigns may have collateral, which may be uploaded in block 414. Collateral may include digital assets, such as logos, pictures, videos, text, as well as customized URIs or URLs that may contain tracking information that may be used with various analytics systems. Collateral may also include physical products, such as samples, give away items, props, or other material.

The campaign may be stored in block 416. A system may process the campaign definition to generate a list of influencer groups, which may be browed in block 418. A user may select a group in block 420 and attempt to negotiate with the group in block 422 to establish agreeable terms for the campaign. If the negotiations are not successful in block 424, the process may return to block 420 to attempt negotiating with another group. When the negotiations are successful in block 424, the campaign may be executed in block 426.

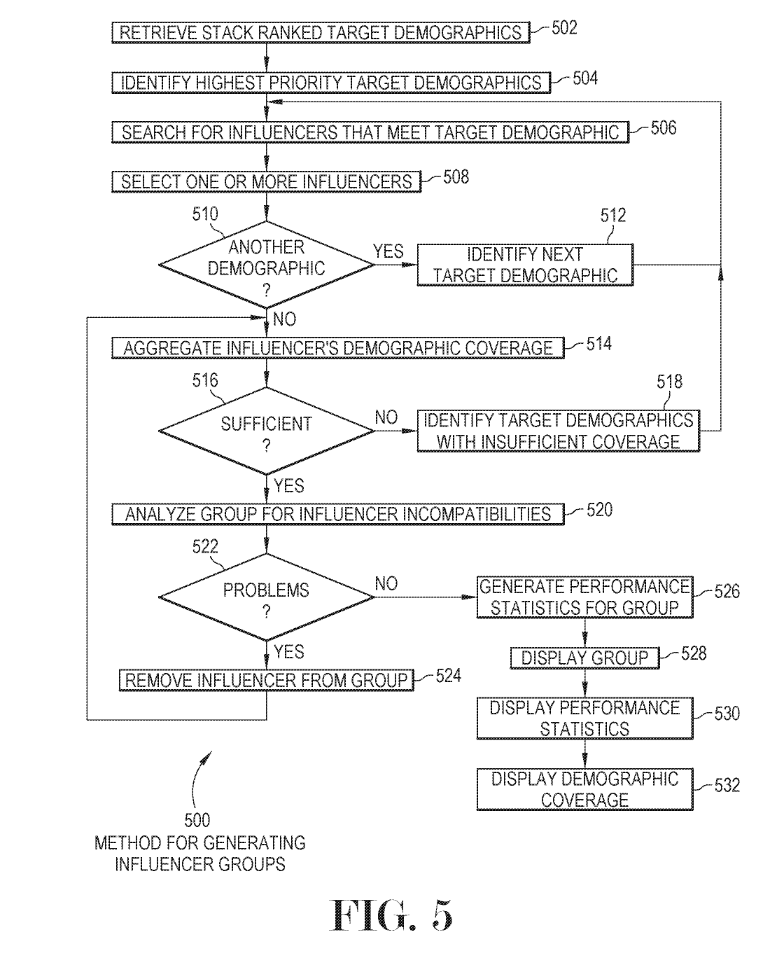

FIG. 5 is a flowchart illustration of an embodiment 500 showing a method that may generate a group of influencers. The process may be performed by a computer system to automatically generate an influencer group in response to a campaign definition received from an advertiser.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 500 is one example of a method by which an influencer group may be generated. The process of embodiment 500 may be performed with or without human interaction, and in many cases, the process may be performed mostly by an automated computer system.

Stack ranked target demographics may be received in block 502. The highest priority target demographic may be identified in block 504, and influencers that meet the target demographic may be searched for in block 506.

The search for an influencer in block 506 may attempt to find influencers who may be able to reach the target demographic. In many cases, the influencer's followers and the influencer's performance history may be analyzed to find an appropriate influencer. In many cases, an influencer may have a large number of followers, which may represent a specific demographic. However, the demographic that may interact with the influencer and that may be likely to respond to an influencer's actions in a campaign may be a different demographic.

The analysis of an influencer's followers and the follower's behavior may be matched against a campaign demographic and geographic goals to estimate how well an influencer may perform for a campaign. In some cases, multiple influencers may be grouped together to match the campaign goal, and one or more influencers may be selected in block 508.

When other demographic or geographic parameters may be analyzed in block 510, the next target demographic or geographic parameter may be selected in block 512 and the process may return to block 506 to find influencers who might reach the next parameter.

All of the influencer's demographic and geographic coverage may be aggregated in block 514. An analysis may be performed to determine if the coverage may be sufficient in block 516. Where there may be holes or areas that may have insufficient coverage in block 516, those demographic or geographic parameters may be identified in block 518 and the process may repeat to add influencers who may cover the insufficient areas.

The influencers in the group may be analyzed in block 520 for any incompatibilities. In some cases, certain influencers may not get along with each other, may advertise for a competitor, or may have some other conflict. When problems may exist in block 522, such influencers may be removed in block 524. The process may return to block 514 to analyze the amended group to see if any holes exist.

When no problems exist in block 522, various performance statistics may be generated for the group in block 526. The performance statistics may be aggregated from each influencer, and in some cases, the statistics may be weighted based on the demographic reach of each influencer.

The group may be displayed in block 528, along with performance statistics in block 530 and demographic and geographic coverage in block 532. At this point, a user may select a group, negotiate a contract, and begin a campaign.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method performed on at least one computer processor, said method comprising:
identifying a plurality of influencer groups, each of said influencer groups comprising a plurality of influencers;
generating at least one statistic for each of said influencer groups;
presenting said plurality of influencer groups and said at least one statistic; and
receiving a user selection of a first influencer group.

2. The method of claim 1, further comprising:
engaging said first influencer group to perform an advertising campaign.

3. The method of claim 1, said at least one statistic comprising an aggregated statistic combined from each of said plurality of influencers.

4. The method of claim 3, said at least one statistic being displayed in a graphical format.

5. The method of claim 3, said at least one statistic being displayed in a numerical format.

6. The method of claim 3, said aggregated statistic being one of a group composed of:
demographic coverage; and
geographic coverage.

7. The method of claim 3, said aggregated statistic being one of a group composed of:
conversion performance;
customer reach; and
user engagement performance.

8. The method of claim 7, said aggregated statistic for a second influencer group being an aggregated statistic being derived from past performance of said second influencer group operating as a group.

9. The method of claim 7, said aggregated statistic for a second influencer group being an aggregated statistic being derived from past performance of said second influencer group operating as individual influencers.

10. The method of claim 1 further comprising:
receiving an advertising request comprising a targeted user description;
identifying a second influencer group meeting said targeted user description; and
identifying said second influencer group as part of said plurality of influencer groups.

11. The method of claim 10 further comprising creating said second influencer group by a method comprising:
identifying a first desired demographic parameter from said targeted user description;
identifying a first influencer having a first following matching a first portion of said first desired demographic parameter;
identifying a second portion of said first desired demographic parameter;
identifying a second influencer having a second following matching said second portion of said first desired demographic parameter, said first portion and said second portion addressing at least a part of said first desired demographic parameter; and
adding said first influencer and said second influencer to said second influencer group.

12. The method of claim 1, said presenting being presenting on a display.

13. The method of claim 1, said presenting being presenting on an application programming interface, said receiving being on an application programming interface.

14. A method performed on at least one computer processor, said method comprising:
receiving a desired demographic profile for an advertising campaign;
identifying a plurality of influencer groups, each of said influencer groups comprising a plurality of influencers;
for each of said plurality of influencer groups, determining a demographic coverage profile;
displaying a plurality of graphical representations, each of said plurality of graphic representations corresponding to one of said influencer groups; and
receiving a selection of a first influencer group.

15. The method of claim 14 further comprising:
displaying at least one demographic statistic for said first influencer group.

16. The method of claim 15, said demographic statistic being an aggregated demographic statistic.

17. The method of claim 16, said aggregated demographic statistic being generated by:
for each of said plurality of influencers, receiving a demographic profile;
aggregating said demographic profile from each of said plurality of influencers to generate said aggregated demographic statistic.

18. The method of claim 16, said aggregated demographic statistic being generated by analyzing past performance of said first influencer group.

19. The method of claim 14 further comprising:
displaying at least one aggregated performance statistic for said first influencer group.

20. The method of claim 19, said at least one aggregated performance statistic being generated by:
for each of said plurality of influencers, receiving a past performance statistic;
aggregating said past performance statistic from each of said plurality of influencers to generate said aggregated performance statistic.
